(19) United States
(12) Patent Application Publication
(10) Pub. No.: US 2004/0211863 A1
(43) Pub. Date: Oct. 28, 2004

(54) Ground pad for minimizing dust and debris

(76) Inventor: William Phelps, Carlsbad, CA (US)

Correspondence Address: William E. Phelps, Suite 108A-342, 300 Carlsbad Village Drive, Carlsbad, CA, 92008, US

(21) Appl. No.: 10/282,320

(22) Filed: Oct. 29, 2002

(51) Int. Cl. B64F 1/00

(52) U.S. Cl. 244/114 R

(57) ABSTRACT

A parachute with a canopy consisting of a plurality of one-way valves that enhance rate of fall in order to provide accurate placement of the parachute of the ground. The one-way valves are placed in a manner to open in response to air directed from below the canopy and close when the canopy in on the ground.

### BACKGROUND

1. Field of Invention

This invention relates to a parachute, specifically to an improvement in the ability to direct the parachute to a desired location, and to ensure, once on the ground, the parachute completely covers a desired area, acting as a ground pad, with the ability to minimize dust and debris caused by Rotary and Vertical Takeoff and Landing aircraft.

2. Discussion of Prior Art

Rotary and Vertical Takeoff and Landing (VTOL) aircraft have problems with dust and debris during takeoffs and landings. The problems center around two areas. First, the engines and other mechanical parts of the aircraft can be damaged or reduced in performance by dust and debris. Second, personnel and equipment, inside, exiting, entering, or in the proximity of, the aircraft are subject to this dust and debris, which degrades the performance of the personnel and equipment. Previous approaches for minimizing dust and debris have been with the use of takeoff and landing pads constructed from concrete or semi-permanent techniques such as metal plating, placed on the ground by personnel. The problem with the existing approaches is that they require time, large scale equipment, and personnel to install, and are not as rapidly installed as some applications require. Covering the ground with a material, such as fabric, would work but would still require ground personnel to install. Covering the ground with a parachute, dropped from an aircraft, would not be functional because the parachute could drift from the desired placement position, due to it's slow rate of fall, and would not always be in the proper shape when it is in it's final ground position. Although a parachute approach to creating a ground pad requires minimal time and personnel to deploy, the problems of drift and proper final shape have not been previously overcome. For fire fighting, Military, and other applications, there is a need for a rapidly deployable ground pad that would require a minimal amount of time to install, be easily deployable, and be effective in minimizing dust and debris.

### OBJECTS AND ADVANTAGES

Accordingly, several objects and advantages of my invention are accuracy of placement, ease of placement, rapid placement, and effectiveness in minimizing dust and debris. The device can be made compact and portable depending upon the specific need of the user. Further objects and advantages of my invention will become apparent from a consideration of the drawings and ensuing description.

### DRAWING FIGURES

FIG. 1 One-way Valve

FIG. 1 show the one-way valve. A sleeve of flexible material 5 that will open when air is directed from the mounting point 8 of the valve to the unrestrained point 4 of the valve and close when air is directed from the unrestrained point 4 of the valve to the mounting point 8 of the valve. A stop cord 9 can be used to minimize the chance of the one-way valve being forced into reverse operation.

FIG. 2 Overall assembly

FIG. 2 shows a cutaway of the assemble. A plurality of one-way valves 10 are used as a major portion canopy 11 of the parachute. A plurality of parachute canopy lines 12 attach the canopy to the main load 13. A main load 13 is attached to the canopy 11 by the canopy lines 12 and constructed by placing a low viscosity substance in relative large containment bag. A stabilizing load 14 is made in the same manner as the main load 13 to improve stability.

### SUMMARY OF THE INVENTION

A plurality of one-way valves are used in the canopy of a ground pad which acts as a parachute with unique drag and stability characteristics while being deployed. With the use of the invented one-way valves in the canopy of such a parachute several different objectives are achieved:

A. The enhanced rate of fall, due to the valves, will minimize the drift of the parachute during transition from release to contact with the ground, associated with the normal parachute design. This allows for accurate placement of the parachute material on the ground.

B. Valve placement, size, and initial packaging will be such that the parachute will open fully once initially released.

C. The invented one-way valves have the feature that they will collapse when the parachute is on the ground, and will not allow air to pass beneath the parachute. In turn, the parachute material on the ground will act to minimize dust and debris associated with Rotary and Vertical Wing aircraft takeoffs and landings.

D. Should the parachute edge be obstructed and not allow to come within full contact with the ground and air is forced, under the parachute, into that area, the one-way valves in that area will re-extend, allowing air to escape, and, in turn, not allow the material to lift, once the parachute is in it's final position.

The edge of the canopy will have a weighted material, such as a nylon rope to add weight around the circumference of the parachute. This will ensure the edge of the parachute will stay on the ground minimizing the effects of high velocity air around the edge of the material.

A variety of materials can be used to ensure the parachute ground pad meets the required levels of durability, and environmental conditions.

The load of the parachute is constructed in a manner as to minimize obstruction once on the ground. A proportionally large flexible container with proportionally small amount of low viscosity material inside will, upon impact with the ground, deform into a low profile object. This will minimize interference with aircraft in landings and takeoffs.

A double pendulum load, one large and one smaller but similar in design to the main load, will act to rapidly stabilize the parachute to ensure the parachute is parallel with the ground, when the parachute makes contact with the ground.

### DESCRIPTION OF INVENTION

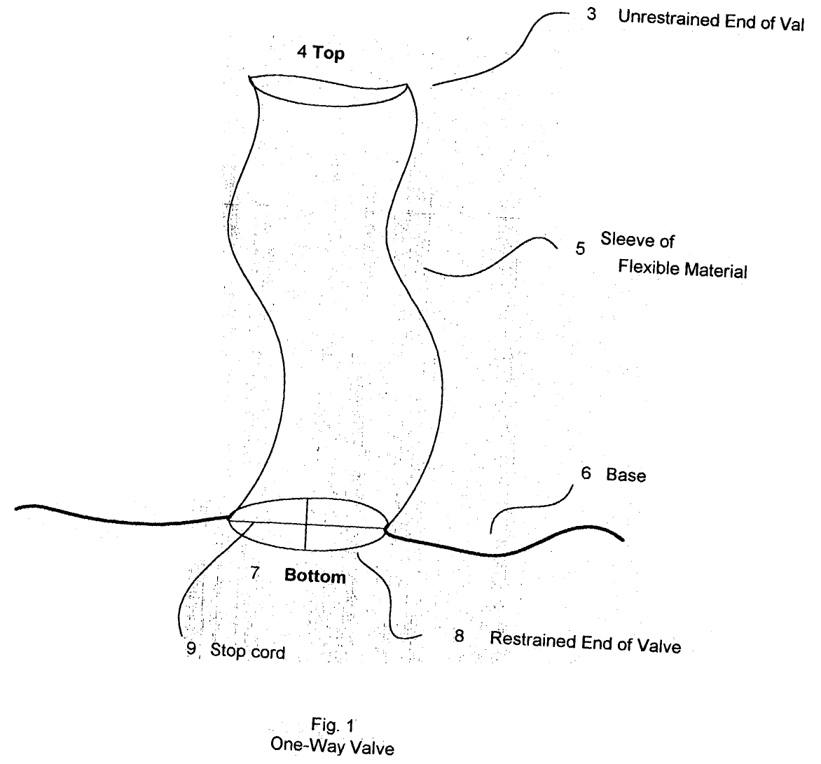

FIG. 1 shows a basic version of the invented one-way valve. A one-way valve is constructed by using a thin-wall hollow sleeve 5, up to several inches in diameter, of flexible material. The sleeve 5 is attached at the bottom 6,8 and unrestrained at the top 4. The length of the sleeve 5 will be between eighteen inches and twenty-four inches. A stop cord 9 can be used to limit reversal of the valve.

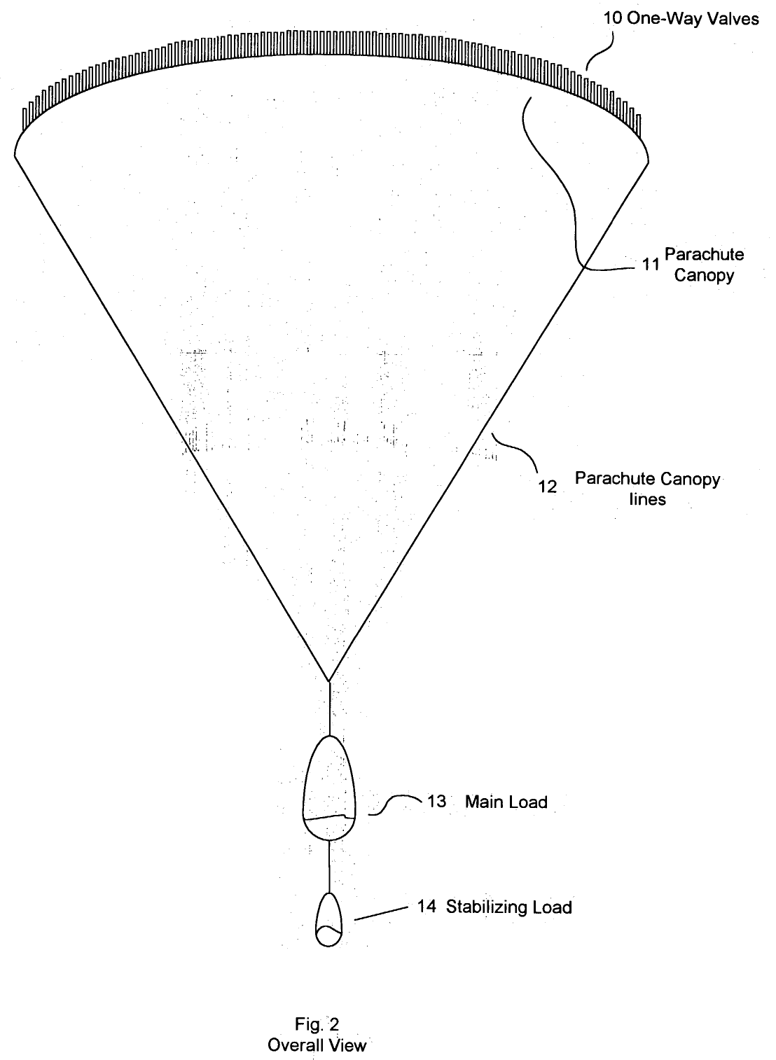

FIG. 2 shows a parachute with a canopy 11 constructed of a plurality of one-way sleeve valves FIG. 1, with the parachute loads 13 attached.

Operation

A container, with enclosed parachute, can be carried under, or contained in, an aircraft. The aircraft will position itself over the point in which the parachute is to be placed on the ground. The doors to the container will be opened, manually or through other mechanical or electromechanical means, and the parachute will be released from the container. Upon release from the container, the parachute will open, the one-way valves will open and allow the parachute to rapidly fall to the ground. The one-way valves are packaged in the container and positioned on the canopy in a manner as to allow complete opening of the parachute after release. The rapid rate of fall will ensure accurate positioning of the parachute on the ground. On the ground, the one-way valves collapse and prevent air from getting below the canopy material. With the canopy material on the ground dust and debris under the canopy will be prevented from disturbance from air motion generated by the aircraft or other means.

### RAMIFICATION AND SCOPE OF THE INVENTION

The invented parachute and one-way valve provide a highly functional approach to minimizing dust and debris caused by Rotary and Vertical Takeoff and Landing (VTOL) aircraft with the features of placement control, rapid placement, and ease of placement.

While particular embodiments of this invention have been shown in the drawings and described above, it will be apparent, that many changes may be made in the form, size, arrangement and positioning of the above elements. In consideration thereof it should be understood that the preferred embodiment of this invention disclosed herein are intended to be illustrative only and not intended to limit the scope of the invention.

I claim:

1. A method to minimize dust and debris for Rotary and Vertical Takeoff and Landing aircraft, said method comprising a ground pad, in the form of a parachute with canopy, consisting of a plurality of one-way valves to facilitate rapid rate and stable motion of fall.

2. A method according to claim 1 wherein a parachute, as known in the art, with a canopy consisting of a plurality of one-way valves to facilitate rapid rate of fall

3. A valve that opens and closes, determined by direction of air or other low viscosity substances
